(19) United States
(12) Patent Application Publication
(10) Pub. No.: US 2022/0234155 A1
(43) Pub. Date: Jul. 28, 2022

(54) MACHINING SYSTEM FOR WORKPIECE MACHINING

(71) Applicant: Festo SE & Co. KG, Esslingen (DE)

(72) Inventor: Ralf Riemensperger, Esslingen (DE)

(21) Appl. No.: 17/583,381

(22) Filed: Jan. 25, 2022

(30) Foreign Application Priority Data
Jan. 27, 2021 (DE) 102021200694.9

(51) Int. Cl. B23Q 3/157; B23Q 3/155

(52) U.S. Cl. CPC B23Q 3/15713; B23Q 3/1554; B23Q 3/15573; B23Q 2003/155446; B23Q 2003/155418; B23Q 2003/155428; B23Q 2003/155439; B23Q 3/1578

(57) ABSTRACT

A machining system for workpiece machining includes a machining cell, to which a workpiece holder for fixing a workpiece, a machining head for machining the workpiece and a robot for workpiece cleaning are assigned, wherein the robot has an articulated robot arm which is mounted with an initial section on a machine frame connected to the machining cell and which is provided at an end section remote from the initial section with a nozzle, which is designed to provide a jet of compressed air, a joint being arranged between the initial section and the end section, wherein the joint is provided with a pneumatic drive for providing a relative movement between the initial section and the end section.

### BACKGROUND OF THE INVENTION

The invention relates to a machining system for workpiece machining with a machining cell, to which a workpiece holder for fixing a workpiece, a machining head for machining the workpiece and a robot for workpiece cleaning are assigned, wherein the robot has an articulated robot arm, which is attached with an initial section to a machine frame connected to the machining cell and which is equipped at an end section facing away from the initial section with a nozzle, which is designed to provide a jet of compressed air, wherein a joint is arranged between the initial section and the end section.

From EP 1 004 393 B1 it is known to perform an automatic tool change on at least one machine tool with a robot serving as a tool changer and having at least six axes. Here, in addition to its task as a tool changer, the robot can also be programmed and used for the targeted blowing off of drill holes.

### SUMMARY OF THE INVENTION

The task of the invention is to provide a machining system in which workpiece cleaning can be performed at low cost.

This task is solved for a machining system of the type mentioned above in that the joint is provided with a pneumatic drive for providing a relative movement between the initial section, which also may be named a base section, and the end section. By using a pneumatic drive, a compact design of the joint is possible. Furthermore, the pneumatic drive enables the use of compressed air as an energy carrier, which must be provided anyway for carrying out cleaning operations for the workpiece. Apart from the fact that the use of compressed air avoids the need to provide different power sources for the operation of the robot, the use of compressed air as an energy carrier for the robot also is advantageous with respect to explosion protection, depending on the cleaning task to be performed. These properties are of particular interest if the machining system is used to perform machining operations in which ignitable mixtures may occur in the machining cell, as may be the case when performing 3D printing processes, for example.

The pneumatic drive can be designed, for example, as a pneumatic cylinder or as a compressed air motor with gear arrangement or as a pneumatic direct drive, in particular as a pneumatic swivel drive, and enables a relative movement for the joint. This relative movement is typically a pivoting movement of the end section with respect to the initial section about a single pivot axis defined by the respective joint. If necessary, it can also be provided that the pneumatic drive is designed for a spatial pivoting movement about several pivot axes and/or for a superimposed translational movement.

Preferably, it is provided that the robot arm comprises a plurality of joints which are arranged between the initial region and the end region and can each be operated individually, so that the nozzle attached to the end region can be brought into the most favorable spatial orientation with respect to the workpiece as a function of a geometry of the workpiece to be cleaned.

Advantageous further embodiments of the invention are the subject of the subclaims.

It is expedient if the machine frame is arranged in the machining cell and if the workpiece holder and/or the machining head are coupled to the machine frame. In this embodiment of the machining system, the robot can perform a cleaning of the workpiece before and/or during and/or after the machining of the workpiece by the at least one machining head. In this case, it is particularly advantageous if the robot is reliably protected against influences such as may be present in the machining cell during and/or after the execution of the machining operation. Such protection is already promoted due to the design characteristics of the pneumatic drive as used for the at least one joint, since an airtight connection between the components of the pneumatic drive that are movable relative to one another is required anyway for proper functioning of the pneumatic drive. Furthermore, it can be assumed that in the event of a malfunction or the occurrence of signs of wear, at most a leakage of compressed air from the pneumatic drive into the machining cell will occur. In the event of such a leakage of compressed air, no danger to the machining process is caused, and in addition, ignition of any ignitable mixture present in the machining cell by the escaping compressed air can also be ruled out.

Preferably, it is provided that the machine frame is arranged outside the machining cell and has a workpiece changing station, and that the initial section of the robot arm is arranged above the workpiece changing station on the machine frame. In this embodiment, the robot can be used to clean workpieces delivered from a previous processing station at the workpiece changing station prior to processing in the machining cell and/or to clean workpieces that have been processed in the machining cell at the workpiece changing station prior to further transport. The advantage here is that the cleaning process can be carried out independently of the machining that is taking place in the machining cell, so that the cleaning does not cause any time delay for the machining of the workpiece in the machining cell. Mounting the robot arm above the workpiece changing station allows good use of space for the machining system, since no additional floor space is required for the robot. By using pneumatic drives for the robot's joints, the robot can be realized with a low overall mass and can be designed and operated in such a way that the robot does not pose a hazard to a user, even when the user is present close to the workpiece changing station.

In a further embodiment of the invention, it is provided that the robot is assigned an electronic control which is designed for actuating a first valve module which is connected to the pneumatic drive and for actuating a second valve module which is connected to the nozzle, and that the joint is assigned a sensors system for detecting a joint position, which sensor system is designed for providing a sensor signal to the electronic control, the electronic control being designed for controlled actuation of the first valve module using the sensor signal. Preferably, the electronic control is or comprises a microcontroller or microprocessor on which a computer program runs, with the aid of which the desired cleaning process for the workpiece can be carried out. For this purpose, the electronic control controls a first valve module, which is connected to the pneumatic drive, or a plurality of first valve modules, each of which is connected to a pneumatic drive, in order to achieve a desired spatial orientation of the end section of the robot arm with respect to the workpiece. Here, the electronic control uses sensor signals from at least one sensor system designed to detect the joint position of the at least one joint and performs a position control (closed loop) for the respective joint by correspondingly actuating the first valve module. Furthermore, the electronic control is designed for actuating a second valve module which is provided for influencing a compressed air flow to the nozzle, the electronic control preferably influencing the compressed air flow provided by the second valve module to the nozzle as a function of the spatial orientation of the nozzle.

In a further embodiment of the invention, it is provided that the first valve module is arranged on the joint and the second valve module is arranged on the machine frame or that the first valve module and the second valve module are arranged on the machine frame. If the first valve module is arranged on the joint or in the immediate vicinity of the joint, it is advantageous that the fluid lines between the first valve module and the pneumatic drive can be kept very short, which supports a spontaneous response of the pneumatic drive to a change in the valve positions of the first valve module. However, in this case it is necessary to run electrical control lines, which run between the electronic control of the first valve module, from the initial section of the robot arm to the respective first valve module. The attachment of the second valve module to the machine frame, in particular in the vicinity of the initial section of the robot arm, is advantageous because the nozzle requires a high mass flow of compressed air and therefore the second valve module must be sufficiently large. Therefore it is advantageous if the second valve module is mounted directly to the machine frame. In an alternative embodiment, it is provided that both the first valve module and the second valve module are mounted to the machine frame. In this case, it is advantageous that apart from fluid lines for connecting the at least one first valve module to the at least one pneumatic actuator and a fluid line for connecting the second valve module to the nozzle, only at least one sensor line from the sensor system associated with the at least one joint has to be routed along the robot arm. In particular, this minimizes the risk of electrical sparking, which means that the robot can also be used in ambient conditions that are subject to the requirements of explosion protection.

Advantageously, the electronic control is associated with a human machine interface configured to be triggered by a user, wherein the electronic control is configured to store a joint position upon receipt of a trigger signal provided by the human machine interface. The human machine interface can be used by a user to store a spatial orientation of the robot in order to establish a path of motion for the robot and nozzle assembly attached thereto as part of a learning process for the electronic control. Such a process is also referred to as “teaching”.

The human machine interface may be located remote from the robot and is in electrical communication with the electronic control. Exemplarily, the human machine interface may be designed as a camera with downstream electronic image processing to store the respective spatial orientation of the robot based on predetermined movements or gestures of the user. Alternatively, the human machine interface can be attached to the surface of the robot, in particular in the immediate vicinity of the nozzle, and can be designed as a pushbutton switch. In this case, the user can bring the robot arm and the nozzle attached thereto stepwise into spatial orientations which are advantageous for the intended cleaning of the workpiece and, when the respective spatial orientation is reached, actuate the human machine interface in order to store this spatial orientation in the electronic control. After completion of the teach-in process, the task of the electronic control is to determine a movement path for the robot arm from the taught-in spatial orientations and then to execute this path by controlling the valve modules accordingly. Depending on the design of the nozzle, it can be provided that the human machine interface also enables a selection of a configuration of the nozzle, for example with regard to the question of which of a plurality of nozzles should be used in the respective spatial orientation of the robot arm or whether, if necessary, no compressed air should be supplied to the nozzle in the specific spatial orientation of the robot arm.

For this purpose, it is particularly advantageous if the human machine interface is arranged at the end section of the robot arm, preferably in the area of the nozzle, and if the electronic control is designed to distinguish between at least two trigger signals of the human machine interface. The arrangement of the human machine interface on the end section of the robot arm makes it possible to ensure particularly intuitive operation of the robot during the teach-in process. A distinction between at least two trigger signals of the input device makes it possible to distinguish between a determination of a spatial orientation of the robot arm and a determination of a start or end of a compressed air supply process for the nozzle. By way of example, it can be provided that a short actuation of the input device serves to define the spatial orientation of the robot arm and a long actuation of the input device influences the compressed air supply.

In an advantageous further embodiment of the invention, it is provided that the nozzle is designed as a compressed air nozzle with an adjustable jet cross-section or is designed as a set of compressed air nozzles from the group: point jet nozzle, fan nozzle, deflection nozzle, with different jet cross-sections. A design of the nozzle as a compressed air nozzle with adjustable jet cross-section can be provided, for example, in such a way that the jet cross-section of the compressed air jet emerging from the nozzle is in a predetermined dependence on a supply pressure which is provided by the second valve module. In this case, the second valve module can be designed as a proportional valve arrangement. Alternatively, an adjustment of the jet cross-section can be provided by an electric or pneumatic actuator acting on the nozzle. In an alternative embodiment, the nozzle includes a set of several compressed air nozzles with different geometries, which can be supplied with compressed air individually or in parallel depending on the requirements for cleaning the workpiece. In this case, it can be provided that a third valve module, which is designed for switching between the different compressed air nozzles, is arranged in the immediate vicinity of the nozzle and can be electrically controlled by the electronic control.

In a further embodiment of the invention, it is provided that the robot arm is surrounded by a, preferably two-layer, protective hose made of flexible, in particular elastic, material. The task of the protective hose is to protect the at least one joint and the at least one pneumatic drive from contamination, such as may be present in the machining cell and/or may occur during cleaning of the workpiece. To enable cost-effective manufacture of the protective hose, the latter is made of a flexible material, in particular a textile material such as a woven fabric. It is advantageous if the flexible material is also elastic so as not to offer a significant resistance to the movements of the robot arm. It is particularly advantageous if the protective hose is made in multiple layers from at least two different materials. In this case, an inner tube can be designed in such a way that it has the lowest possible sliding friction with respect to the robot arm and the outer tube arranged coaxially with the inner tube, in the manner of an inner lining of a garment. In this case, the outer hose is used to ensure that the robot arm is sealed off from environmental influences and can preferably be designed to be waterproof and/or dustproof within a predefined range of use.

Preferably, it is provided that a compressed air inlet for providing an overpressure with respect to an environment of the robot arm is assigned to a spatial volume delimited by the protective hose. This measure can ensure that no undesirable ingress of contamination occurs even at interfaces between the protective hose and the robot arm, the tightness of which is often difficult to guarantee.

### BRIEF DESCRIPTION OF THE DRAWINGS

An advantageous embodiment of the invention is shown in the drawing. Here shows:

FIG. 1 a strictly schematic overview of a processing system,

FIG. 2 a front view of an end section of the robot arm with a sensor system associated with the joint,

FIG. 3 a rear view of the end section of the robot arm according to FIG. 2 with a sectional view of the pneumatic drive, and

FIG. 4 a variant of a nozzle for the robot arm according to FIGS. 1 to 3.

### DETAILED DESCRIPTION

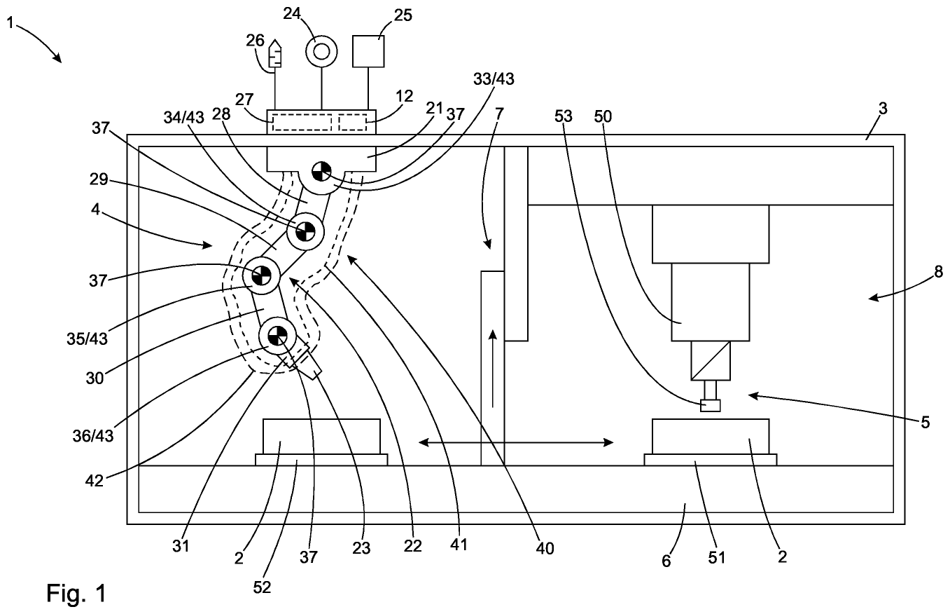

A machining system 1 shown purely schematically in FIG. 1 is designed as a milling center and enables a workpiece 2 to be machined. For this purpose, the machining system 1 comprises a box-shaped machine frame 3, to which a robot 4, a machining head 5, a workpiece carrier plate 6 and a workpiece lock 7 are attached.

The machine frame 3, which is shown only schematically, is provided with planking on all side surfaces in a manner not shown in greater detail, so that a spatial section is formed which is sealed off from an environment of the machining system 1 and which can also be referred to as a machining cell 8.

The robot 4 has a base-like initial section 21 that is fixedly attached to an upper surface of the machine frame 3. Connected to the initial section 21 is a robot arm 22 which, purely by way of example, comprises a first arm part 28, a second arm part 29, a third arm part 30 and a fourth arm part 31, as well as associated joints 33, 34, 35 and 36 for the articulated connection of respectively adjacently arranged arm parts 28, 29, 30 and 31. In this case, the fourth arm part 31 forms, purely by way of example, the end section of the robot arm 22 and is provided at the end with a nozzle 23. For reasons of clarity, all joints 33 to 36 are shown in the drawing in such a way that their swivel axes 37 are aligned normal to the plane of representation of FIG. 1. In practice, the swivel axes of the joints 33 to 36 can be arranged in different spatial orientations relative to one another.

Starting from the initial section 21 up to the nozzle 23, the robot arm 22 is surrounded by a protective hose 40 which is designed to seal off the robot arm 22 from environmental influences such as may be present in the machining cell 8. By way of example, the protective hose 40 has two layers and comprises an inner hose 41 and an outer hose 42.

Associated with the initial section 21 of the robot 4 are a source of compressed air 24, a source of electrical power 25, and a fluid outlet 26 provided with a muffler. Furthermore, an electronic control 27 and a second valve module, the function of which will be described in more detail below, are accommodated in the initial section 21.

The machining head 5 is connected to the machine frame 3 via a multi-axis manipulator 50, which is configured to allow a milling tool 53 to move in three dimensions in order to allow the workpiece 2 to be machined as completely as possible. A supply of cooling lubricant from the machining head 5 to the milling tool 51 may be provided for carrying out a workpiece machining operation. In any case, the machining of the workpiece 2 results in a contamination of the workpiece 2 by chips which are to be removed before further transport of the workpiece 2 by means of the robot 4.

By way of example, it is provided that a conveyor, which is not shown, is integrated in the workpiece carrier plate 6, which is only shown schematically, and which conveyor is designed for a movement of the workpiece 2 between a workpiece holder 51 arranged below the machining head 5 and a workpiece changing station 52 arranged below the robot 4. The conveyor enables a rapid exchange of workpieces 2 between the workpiece changing station 52 and the workpiece holder 51, whereby a simultaneous machining of a workpiece 2 with the machining head 5 as well as a cleaning of a further workpiece 2 can preferably be carried out with the robot 4.

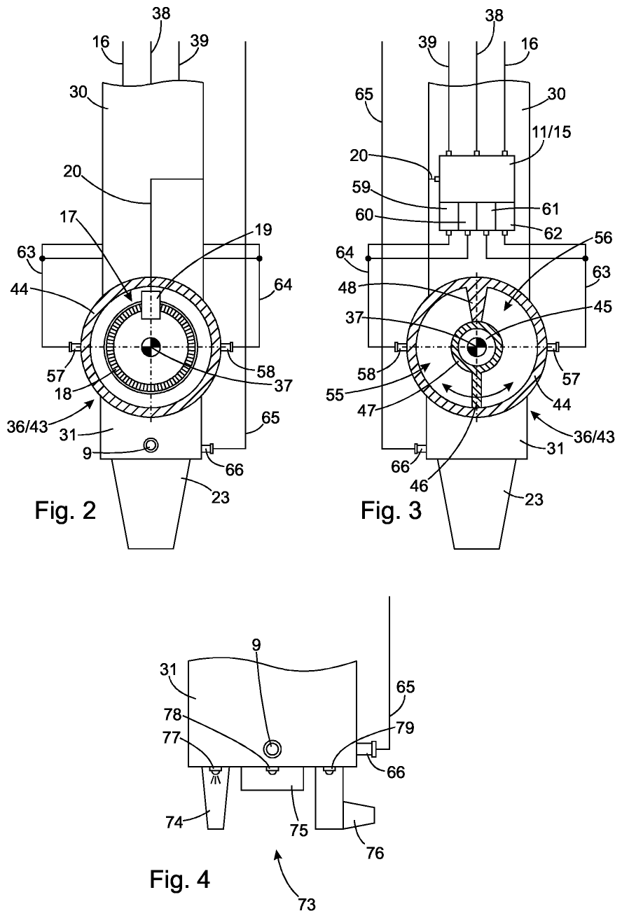

Purely by way of example, the machining cell 8 is divided by a workpiece lock 7 into a working area, in which the machining head 5 and the workpiece holder 51 are arranged, and into a changing area, in which the robot 4 and the workpiece changing station 52 are arranged. The workpiece lock 7 can be opened for the exchange of workpieces 2 and is closed during the machining of the workpiece 2 or the cleaning of the workpiece 2. In FIGS. 2 and 3, the joint 36 arranged between the third arm part 30 and the fourth arm part 31 is shown from two opposite spatial directions. The joint 36 is representative of the other joints 33 to 35, which are preferably of the same type, in particular identical, as the joint 36.

Purely exemplarily, the joint 36 which is arranged between the third arm part 30 and the fourth arm part 31 also includes the pneumatic drive 43, which is designed as a pneumatic swivel drive and which enables a limited swivel movement between the third arm part 30 and the fourth arm part 31 about the swivel axis 37 aligned normal to the plane of representation of FIGS. 2 and 3.

By way of example, the pneumatic actuator 43 comprises an annular actuator housing 44 extending along the pivot axis 37 and having an outer surface connected to the third arm portion 30.

As can be seen from the illustration of FIG. 3, a drive shaft 45 is rotatably mounted in the drive housing 44, which is connected to the fourth arm part 31 and which determines the pivot axis 37. Fixed to the drive shaft 45 is a sealing sleeve 47 which carries a working vane 46 extending outwardly in the radial direction. The working vane 46, together with the undesignated inner surface of the drive housing 44 and a sealing ridge 48 of the drive housing 44 projecting inwardly in the radial direction, defines a first working chamber 55 and a second working chamber 56. In this regard, the working vane 46 and the sealing sleeve 47 are pivotally sealingly received in the drive housing 44, thereby allowing the volume of the first working chamber 55 and the second working chamber 56 to be varied.

A fluid connection 57, 58 is associated with each of the working chambers 55, 56, via which a supply and discharge of compressed air into and out of the respective working chamber 55 resp. 56 from the respective working chamber 55 or 56 can be carried out. In the presence of a pressure difference between a first fluid pressure in the first working chamber 55 and a second fluid pressure in the second working chamber 56, there is a resulting force effect on the working vane 46, which leads to a torque on the drive shaft 45, whereby a pivoting movement of the fourth portion 31 relative to the third arm portion 30 can be caused.

A compressed air supply and a compressed air discharge for the first working chamber 55 are provided via a first fluid line 63 connected to the first fluid port 57 and connected to a first control valve 59 and a second control valve 60. In a purely exemplary manner, the first control valve 59 is provided as a venting valve and controls a fluid flow from the compressed air source 24 into the first working chamber 55. In an exemplary embodiment, the second control valve 60 is provided as a venting valve and allows venting of the first working chamber 55 via the fluid outlet 26. Similarly, the second working chamber 56 is connected via a second fluid line 64 to a third control valve 61 and a fourth control valve 62, by means of which it is also possible to pressurize or vent the second working chamber 56. The control valves 59 to 62 are fluidically connected to the compressed air source 24 and the fluid outlet 26, respectively, depending on their assigned task. The control valves 59 to 62 are fluidically connected to the compressed air source 24 or the fluid outlet 26, depending on their assigned task, and are electrically connected to a valve control 15 mounted directly on the third arm part 30, which is also referred to as the first valve module. Depending on the design of the control valves 59 to 62, which can be selected, for example, from the group: switching valves, proportional valves, the valve control 15 is set up to control the control valves 59 to 62 as required depending on control signals which are provided by the electronic control 27 via a control line 16. Furthermore, the valve control 15 is connected to the compressed air source 24 via a compressed air line 38 and to the fluid outlet 26 via an outlet line 39 and can thus influence compressed air flows to the pneumatic drive 43 or from the pneumatic drive 43.

Furthermore, according to the representation of FIG. 2, it is provided that a sensor system 17 is arranged in the drive housing 44, which comprises an encoding disk 18 connected to the drive shaft 45 in a rotationally fixed manner and a sensor 19, wherein the sensor 19 is electrically connected to the valve control 15 via a sensor line 20. By way of example, the coding disk 18 has an optically or magnetically scannable incremental or absolute coding arranged in an annular manner coaxially with the pivot axis 37, which is scanned by the sensor 19. The sensor 19 provides a sensor signal, dependent on the result of the scanning, to the valve control 15 via the sensor line 20. Depending on the design of the valve control 15 as well as the electronic control 27, it may be provided that a control of a swivel position is performed by the valve control 15. In this case, a swivel angle information for the fourth joint 36 is provided by the electronic control 27. Alternatively, it can be provided that the sensor signal of the sensor 19 is forwarded to the electronic control 27 without intermediate processing in the valve control 15, where a comparison is made between a stored setpoint value and an actual value for the pivoting position of the fourth joint 36. From any deviation between the setpoint value and the actual value, the electronic control 27 then determines suitable control signals which are transmitted to the valve control 15 and are converted there into corresponding valve control signals for the control valves 59 to 62.

A pneumatic supply to the nozzle 23, which is arranged at the end of the fourth arm part 31, is provided via a fluid supply line 65 which, starting from the second valve module 12, which is accommodated purely exemplarily in the initial section 21 and which is connected to the compressed air source 24, extends to the end of the fourth arm part 31 and is connected there to a fluid connection 66 of the nozzle 23.

Furthermore, a human machine interface 9 is associated with the fourth arm portion 31, which human machine interface is designed, for example, as an electrical push-button switch and which is connected to the electronic control 27 via an electrical line which is not shown. The human machine interface 9 makes it possible, for example, to store joint positions of the joints 33 to 36 which the robot arm 22 is to assume in order to carry out a cleaning operation for the workpiece 2. Purely by way of example, it can be provided that such a storage of joint positions is carried out by briefly actuating the human machine interface. Furthermore, it can be provided that a setting of a jet cross-section for the nozzle 23, which is designed to be adjustable in a manner not shown in more detail, may be set by a longer-lasting actuation of the human machine interface 9 in the respective cleaning position.

In an alternative embodiment of a nozzle 73, as shown in FIG. 4, this nozzle 73 is a system which comprises three differently designed compressed air nozzles 74, 75, 76 which are arranged on the fourth arm part 31 in a purely exemplary manner The compressed air nozzles 74, 75, 76 can be controlled by a valve arrangement arranged in the fourth arm part 31, not shown, which is electrically connected to the electronic control 27, in an alternative or parallel manner for providing compressed air.

Purely by way of example, each of the compressed air nozzles 74, 75, 76 is assigned a respective indicator lamp 77, 78, 79, by means of which it can be indicated which of the compressed air nozzles 74, 75, 76 is to be activated during the performance of the teach-in process. Switching between the compressed air nozzles 74, 75, 76 can be carried out, for example, with the aid of the human machine interface 9. Alternatively, it can be provided that a, in particular capacity based, scanning of the compressed air nozzles 74, 75, 76 is carried out by the electronic control 27 or the valve control 15 and user inputs are detected by this scanning process. By way of example, during the execution of the teach-in process, a user can, by touching the respective compressed air nozzle 74, 75, 76, select an activation position and/or an activation time for the use of the respective compressed air nozzle 74, 75, 76 during the subsequent execution of the cleaning process and receives a visual feedback about the respective activation carried out by the associated indicator lamp 77, 78, 79. In addition, it can be provided that, for example, the storage of a position of the robot 4 is triggered by a longer lasting contact with one of the compressed air nozzles 74, 75, 76.

What is claimed is:

1. A machining system for machining of a workpiece, comprising a machining cell, to which a workpiece holder for fixing a workpiece, a machining head for machining the workpiece and a robot for workpiece cleaning are assigned, wherein the robot has an articulated robot arm which is mounted with an initial section to a machine frame, which machine frame is connected to the machining cell, wherein the robot arm is provided at an end section remote from the initial section with a nozzle, which nozzle is designed to provide a jet of compressed air and wherein a joint is arranged between the initial section and the end section, wherein the joint is provided with a pneumatic drive for providing a relative movement between the initial section and the end section.

2. The machining system according to claim 1, wherein the machine frame is arranged in the machining cell and that the workpiece holder and/or the machining head are coupled to the machine frame.

3. The machining system according to claim 1, wherein the machine frame is arranged outside the machining cell and comprises a workpiece changing station, and wherein the initial section of the robot arm is arranged above the workpiece changing station on the machine frame.

4. The machining system according to claim 1, wherein the robot is assigned an electronic control, a first valve module which is connected to the electronic control and to the pneumatic drive a second valve module which is connected to the electronic control and to the nozzle, wherein the joint is assigned a sensor system for detecting a joint position, which sensor system provides a sensor signal to the electronic control, the electronic control controls the first valve module using the sensor signal.

5. The machining system according to claim 4, wherein the first valve module is arranged on the joint and the second valve module is arranged on the machine frame or wherein the first valve module and the second valve module are arranged on the machine frame.

6. The machining system according to claim 4, wherein the electronic control comprises a human machine interface for a user input, wherein the electronic control stores a joint position upon a trigger signal of the human machine interface.

7. The machining system according to claim 6, wherein the human machine interface is arranged at the end section of the robot arm and wherein the electronic control distinguishes between at least two different trigger signals of the human machine interface.

8. The machining system according to claim 1, wherein the nozzle is a compressed-air nozzle with adjustable jet cross section or comprises a set of compressed-air nozzles from the group: point-jet nozzle, fan nozzle, deflection nozzle, with different jet cross sections.

9. The machining system according to claim 1, wherein the robot arm is surrounded by a protective hose made of flexible material.

10. The machining system according to claim 9, wherein a compressed air inlet for providing an overpressure with respect to an environment of the robot arm is assigned to a spatial volume delimited by the protective hose.
